(19) United States
(12) Patent Application Publication
(10) Pub. No.: US 2025/0019256 A1
(43) Pub. Date: Jan. 16, 2025

(54) Manufacturing Method for Disordered Rocksalt-Cathode Active Material and Manufacturing Method for Cathode Material Using the Same

(71) Applicant: THE ROYAL INSTITUTION FOR THE ADVANCEMENT OF LEARNING/MCGILL UNIVERSITY, Montreal (CA)

(72) Inventors: Jinhyuk LEE, Montreal (CA); Dong Hwa SEO, Ulsan (KR); Eun Ryeol LEE, Ulasn (KR); Dae-Hyung LEE, Ulsan (KR); Sang Wook PARK, Ulsan (KR)

(21) Appl. No.: 18/770,029

(22) Filed: Jul. 11, 2024

(30) Foreign Application Priority Data
Jul. 11, 2023 (KR) 10-2023-0089965

(51) Int. Cl. C01G 45/12; H01M 4/02; H01M 4/13915; H01M 4/62

(52) U.S. Cl. CPC C01G 45/1228; H01M 4/13915; H01M 4/622; H01M 4/625; C01P 2002/72; C01P 2006/40; H01M 2004/028

(57) ABSTRACT

There is provided a method of manufacturing a disordered rocksalt-cathode active material of Formula 1:

Li_{0.4+x}M1_{y}M2_{z}O₂₋ₖFₖ (1)
Wherein, 0<x≤1.6, 0≤z≤1, 0≤k≤0.660<y≤1 and (x+y+z)≤1.6, and wherein M1 is a redox center selected from Mn, Ni, V, Co, Fe, Ir, Cr, Ru, Mo, and combinations thereof, and M2 is a d⁰ transitional metal selected from Ti, Zr, V, Nb, Sn, Mo and combinations thereof. The value of y is determined for a species of M1 based on a selection of the other parameters in order to maximize the electrical conductivity. Mathematical simulations that leverage the polaron energy barrier are used to determine the percolation probability and the accessibility of M1 in the percolation network. This allows to select for values of y to obtain a proportion of accessible M1 of at least 90% to improve electrical conductivity and manufacture the active material accordingly.

### CROSS-REFERENCE TO A RELATED APPLICATION

This disclosure claims priority from Korean Application Number 10-2023-0089965 filed on Jul. 11, 2023 which is incorporated by reference in its entirety.

### TECHNICAL FIELD

This disclosure relates to the field of cathode materials and methods of manufacturing same.

### BACKGROUND OF THE ART

The replacement of fossil fuels to reduce the environmental pollution they cause is an ongoing effort. Fossil fuels are often used as an energy and this energy source is being replaced in certain industries by electric energy. To support the use of electric energy which can advantageously come from renewable sources, the use of batteries to store and discharge the electrical energy has become more and more prevalent. The cathode material used for the battery is for example based on LiNiₓCo_{y}Mn_{z}O₂ (where x+y+z=1). There are however limitations with the use of such transitional metals, in particular there are limitations with regards to the energy density. To palliate to these deficiencies, a lithium-excess disordered rocksalt material was developed.

The advantage of a lithium-excess disordered rocksalt cathode material is its high energy capacity which can for example be around 1000 Wh/kg. Unfortunately, due to low electrical conductivity of the material, there is a need for the use of a large amount of carbon-based conductive material (e.g., carbon black) in a concentration of from 10 to 20% in the cathode. As a result, the energy density at an actual cathode level is reduced to around 700 Wh/kg, and the high energy density characteristic which is the advantage of the lithium-excess disordered rocksalt cathode material is lost. Accordingly, although the lithium-excess disordered rocksalt cathode material has shown an improved energy capacity, it is difficult to practically implement at the electrode level. Therefore, in order to implement high energy density performance of disordered rocksalt cathode materials, it would be desirable to improve their electrical conductivity characteristics while maintaining their increased energy capacity.

### SUMMARY

In one aspect, there is provided a method of manufacturing a disordered rocksalt-cathode active material, the method comprising:
selecting values of x, z and k in Formula 1:

Li_{0.4+x}M1_{y}M2_{z}O₂₋ₖFₖ (1)
Wherein, 0<x≤1.6, 0≤z≤1, 0≤k≤0.66, and wherein M1 is a redox center selected from the group consisting of Mn, Ni, V, Co, Fe, Ir, Cr, Ru, Mo, and combinations thereof, and M2 is a d⁰ transitional metal selected from the group consisting of Ti, Zr, V, Nb, Sn, Mo and combinations thereof;
determining a value of y in Formula 1, wherein 0<y≤1 and (x+y+z)≤1.6, for a composition of M1 and M2 by first performing step A, then second performing step B and/or step C, and then third performing step D which are as follows:
   determining polaron energy barriers for the disordered rocksalt-cathode active material with y varying from more than 0 to up to 1,
   determining a percolation probability by using the polaron energy barriers determined in Step A and performing a Monte Carlo simulation assuming a random crystal structure for the disordered rocksalt-cathode active material, to determine a proportion of M1 that is accessible and is part of a percolating network of the disordered rocksalt-cathode active material as opposed to M1 that is inaccessible and is not part of the percolating network,
   determining a second percolation probability by using the polaron energy barriers determined in Step A and performing a Markov Chain Monte Carlo simulation assuming a short-range ordering of the crystal structure of the disordered rocksalt-cathode active material, to determine a proportion of M1 that is accessible and is part of a percolating network of the disordered rocksalt-cathode active material as opposed to M1 that is inaccessible and is not part of the percolating network,
   selecting a value of y such that a ratio of M1 defined as follows is of at least 90%:

$$ratio of M 1 = \frac{accessible M 1}{total M 1}$$

wherein total M1 is the sum of the accessible M1 and not accessible M1, and wherein a proportion of accessible M1 is obtained from step B and/or C;
synthesizing the disordered rocksalt-cathode active material by mixing amounts of Li, M2, O and F as per the selected values of x, z, and k and further mixing an amount of M1 as per the selected value of y according to step D in order to obtain the disordered rocksalt-cathode active material.

In some embodiments, in step D, the ratio of M1 that is accessible and included in the percolating network is of at least 90% as determined in both steps B and C.

In some embodiments, the disordered rocksalt-cathode active material has a structure included in a cubic Fm-3m space group having a peak of the (400) plane around 45 degrees (2θ) in an X-ray diffraction (XRD) pattern, or has a structure included in a cubic Fd3m space group having a peak of the (400) plane around 45 degrees (2θ) and a peak of the (111) plane around 20 degrees (2θ) in the XRD pattern.

In some embodiments, the Monte Carlo simulation in step B applies an edge-sharing M1-M1 configuration-based calculation, an edge- and corner-sharing M1-M1 configuration-based calculation, or both.

In some embodiments, the Markov chain Monte Carlo simulation in step C applies an edge-sharing M1-M1 configuration-based calculation, an edge- and corner-sharing M1-M1 configuration-based calculation, or both.

In some embodiments, M1 is selected from the group consisting of Mn, V, Cr, Mo, Ni, Co, and combinations thereof. In some embodiments, M1 is selected from the group consisting of Mn, Ni, Co, and combinations thereof. In some embodiments, M1 is Mn.

In some embodiments, M2 is selected from the group consisting of Ti, Nb and combinations thereof.

In one aspect, there is provided a method of producing a cathode, the method comprising:
manufacturing an active material by performing the method as defined herein to obtain the disordered rocksalt-cathode active material;
combining the active material, a conductive material and a binder in a weight ratio of (the active material):(the conductive material):(the binder) being (70+x):(20−y):z respectively wherein 0<x≤26, 0<y≤18, 2≤z≤10 and (x−y+z)=10 to obtain the cathode.

In some embodiments, the weight ratio has a value of x that is 15<x≤26.

In some embodiments, the weight ratio has a value of x that is 20≤x≤26.

In some embodiments, the weight ratio has a value of y of from 10≤y≤18.

In some embodiments, the weight ratio has a value of y of from 15≤y≤18.

In some embodiments, the binder is selected from poly(vinylidene fluoride) (PVDF), polyvinylidene fluoride-co-hexafluoropropylene, polyvinylidene fluoride-co-trichloroethylene, polyvinylidene fluoride-co-tetrafluoroethylene, polyvinylidene fluoride-co-trifluoroethylene, polyvinylidene fluoride-co-trifluorochloroethylene, polyvinylidene fluoride-co-ethylene, ethylene/tetrafluoroethylene copolymers (ETFE), fluorinated ethylene/propylene copolymers (FE P), tetrafluoroethylene/perfluoroalkoxyvinyl copolymers (PFA), tetrafluoroeth-ylene/hexafluoropropylene/vinylidene fluoride terpolymers (THV), perfluoro rubbers (PFR), glassy amorphous fluoropolymers, Polytetrafluoroethylene (PTFE), styrene-butadiene rubber (SBR), sodium salt of carboxymethyl cellulose (CMC), poly(acrylic acid) (PAA) and poly(amide imide) (PAI) and combinations thereof.

In some embodiments, the conductive material is a carbon nanotube-based conductive material which comprises a multi-walled carbon nanotube (MWCNT), a single-walled carbon nanotube (SWCNT), or both. In some embodiments, the carbon nanotube-based conductive material has a diameter of 1 nm to 20 nm and a length of 1 μm to 50 μm. In some embodiments, the carbon nanotube-based conductive material comprises a carbon nanotube-based conductive material (A) having an aspect ratio (length/diameter) of 1000 or less, a carbon nanotube-based conductive material (B) having an aspect ratio (length/diameter) of 1000 to 10,000, or both (A) and (B). In some embodiments, a mass ratio of the carbon nanotube-based conductive material (A) to the carbon nanotube-based conductive material (B) is from 1:1 to 1:10. In some embodiments, a bulk volume of the conductive material is 1 cm³/g to 100 cm³/g.

Many further features and combinations thereof concerning the present improvements will appear to those skilled in the art following a reading of the instant disclosure.

### DESCRIPTION OF THE DRAWINGS

FIG. 1 is a graph showing the electrochemical characteristics of a disordered rocksalt structure Li_{1.2}Mn_{0.4}Ti_{0.4}O₂ (LMTO, 0.4 Mn per X₂ (X=anion))-cathode material (voltage vs. Li in function of the specific capacity).

FIG. 2 is a graph showing the electrical conductivity of a disordered rocksalt structure-cathode material with different concentrations of the redox center metal (Mn).

FIG. 3A is a graph showing the electrochemical characteristics of a partial-spinel disordered rocksalt structure-cathode material (Li_{1.68}Mn_{1.60}O_{3.7}F_{0.3} (LMOF, top, center, 0.8 Mn per X₂ (X=anion)) based on different weight ratios of LMOF:conductive material:binder. They are related with Li_{1.68}Mn_{1.60}O_{3.7}F_{0.3} (LMOF, top, center, 0.8 Mn per X₂ (X=anion)), Li_{1.68}Mn_{1.30}Ti_{0.30}O_{3.7}F_{0.3} (T30, bottom, left, 0.65 Mn per X₂ (X=anion)) and Li_{1.68}Mn_{1.15}Ti_{0.45}O_{3.7}F_{0.3} (T45, bottom, right, 0.575 Mn per X₂ (X=anion)).

FIG. 3B is a graph showing the electrochemical characteristics of a partial-spinel disordered rocksalt structure-cathode material (T30, bottom, left, 0.65 Mn per X₂ (X=anion)) based on different weight ratios of T30:conductive material:binder.

FIG. 3C is a graph showing the electrochemical characteristics of a partial-spinel disordered rocksalt structure-cathode material (T45, bottom, right, 0.575 Mn per X₂ (X=anion)) based on different weight ratios of T45:conductive material:binder.

FIG. 4A is a schematic showing a lattice.

FIG. 4B is a schematic showing an edge-sharing path.

FIG. 4C is a schematic showing a corner-sharing path.

FIG. 4D is a graph showing the polaron energy barriers according to a percolation path (conduction path).

FIG. 5A is a bar graph showing the percolation probability and average Mn content for a random-based disordered rocksalt-cathode structure based on the edge-sharing Mn—Mn configuration-based calculation.

FIG. 5B is a bar graph showing the percolation probability and ratio of accessible Mn for a random-based disordered rocksalt-cathode structure based on the edge-sharing Mn—Mn configuration-based calculation.

FIG. 5C is a bar graph showing the percolation probability and average Mn content for a random-based disordered rocksalt-cathode structure based on the edge-sharing and corner-sharing Mn—Mn configuration-based calculation.

FIG. 5D is a bar graph showing the percolation probability and ratio of accessible Mn for a random-based disordered rocksalt-cathode structure based on the edge-sharing and corner-sharing Mn—Mn configuration-based calculation.

FIG. 6A is a bar graph showing the percolation probability and average Mn content for a disordered rocksalt-cathode structure based on short-range ordering and on the edge-sharing Mn—Mn configuration-based calculation.

FIG. 6B is a bar graph showing the percolation probability and ratio of accessible Mn for a disordered rocksalt-cathode structure based on short-range ordering and on the edge-sharing Mn—Mn configuration-based calculation.

FIG. 6C is a bar graph showing the percolation probability and average Mn content for a disordered rocksalt-cathode structure based on short-range ordering and on the edge-sharing and corner-sharing Mn—Mn configuration-based calculation.

FIG. 6D is a bar graph showing the percolation probability and ratio of accessible Mn for a disordered rocksalt-cathode structure based on short-range ordering and on the edge-sharing and corner-sharing Mn—Mn configuration-based calculation.

### DETAILED DESCRIPTION

There is provided herein a method of manufacturing a disordered rocksalt-cathode active material which has a lithium excess (Li from 0.4 to 2 as per Formula 1 described below) and demonstrates an improved electrical conductivity. This improved electrical conductivity allows to reduce the content of carbon-based conductive materials while maintaining desirable properties of electrical conductivity and energy capacity. Accordingly, the present disordered rocksalt-cathode active material allows to decrease the carbon-based material in the cathode without significantly loosing on electrical conductivity. To achieve this, it has been found that the redox center of the disordered rocksalt-cathode active material is an important concentration to tune. More particularly, it is important to determine whether the redox center is accessible and is part of the percolating network. The percolating network is indicative of the electrical conductivity, however, it has been found that a more than 95% percolation probability is not indicative of the proportion of accessible redox centers. Therefore, determining whether a high enough percentage of redox centers are accessible (e.g. at least 95%, at least 97% or at least 98%) was found to be the determining factor in improving the electrical conductivity. As previously explained, this increase in electrical conductivity for the disordered rocksalt-cathode active material allows to reduce the content of carbon-based conductive material and thus improve the energy capacity of the cathode.

The present disclosure relates to disordered rocksalt-cathode active material of Formula 1:

Li_{0.4+x}M1_{y}M2_{z}O₂₋ₖFₖ (1).

where, 0<x≤1.6, 0<y≤1, 0≤z≤1, 0≤k≤0.66 and where (x+y+z)≤1.6, M1 (redox center) is selected from the group consisting of Mn, Ni, V, Co, Fe, Ir, Cr, Ru, Mo and combinations thereof, and M2 (d⁰ transition metal) is selected from the group consisting of Ti, Zr, V, Nb, Sn, Mo and combinations thereof. In some embodiments, in chemical Formula 1, x can be: 0<x≤1.6, 0<x≤1.5, 0<x≤1.2, or 0<x≤1. In some embodiments, in Chemical Formula 1, the M1 (redox center) is selected from Mn, V, Cr, Mo, Ni and Co, preferably is selected from Mn, Ni and Co and more preferably is Mn. In some embodiments, in Chemical Formula 1, M2 (d⁰ metal) may include at least one of Ti, Zr, V, Nb, Sn and Mo or any combinations of two or more thereof. In some cases, M2 (d⁰ metal) is selected from Ti, Nb and combinations thereof.

The disordered, open structure, is conductive to facilitate efficiency lithium-ion storage. More specifically, the disordered open network structures can both effectively accommodate the mechanical stresses and volume changes upon lithiation/delithiation, and facilitate an isotropic transport of Li⁺ ions. Other advantages of a disordered structure include the presence of abundant defects in their structure to provide more reaction sites for Li⁺, thereby enhancing the specific capacity. Disordered structure also have easy tunability by modifying the composition and structure to optimize the end-properties. Last but not least, disordered materials are less likely to undergo a phase transition during the electrochemical reactions but may experience nano-crystallization during charge/discharge cycling. The latter leads to a significant improvement in their cycling stability.

To increase the electrical conductivity of the disordered rocksalt-cathode active material of Formula 1, the important component to tune is the redox center. Accordingly, for given values of x, z and k, an optimal value of y or a range of values for y can be determined such that the electrical conductivity is optimized. As demonstrated in the Example section below, to determine a value of y, first polaron energy barriers are determined according to an electron conduction path of the disordered rocksalt-cathode active material. The polaron energy barriers are calculated using density functional theory (DFT) is an electronic structure calculation method that is widely used in the field of physical chemistry, material science, and condensed matter physics. Gaussian program is one of the most frequently used computational chemistry packages for DFT calculations. DFT is a first-principles calculation, or ab initio, because it starts directly at the level of established laws of physics and does not make assumptions such as empirical models and fitting parameters.

The polaron energy barriers can then be used to calculate the percolation probability considering different concentration of M1 in order to determine the concentration or concentration range that provides the maximum of electrical conductivity. The percolation probability can be calculated using one of two ways (or both). The first way is a Monte Carlo simulation which assumes a random crystal structure for the disordered rocksalt-cathode active material. The second way is a Markov Chain Monte Carlo (MCMC) simulation which assumes a short-range ordering of the crystal structure of the disordered rocksalt-cathode active material. A Monte Carlo simulation is a type of computational algorithm that uses repeated random sampling to obtain the likelihood of a range of results of occurring. However, whereas the random samples of the integrand used in a conventional Monte Carlo integration are statistically independent, those used in MCMC are autocorrelated. The MCMC assumes a short-range order of the crystal structure. The term “short-range order” refers to the regular and predictable arrangement (i.e. crystalline lattice) of atoms over a short distance, usually within one or two atom spacings. Short Range Order (SRO) signifies the systematic arrangement of atoms or molecules within a limited spatial range in a material. It should be noted that both simulations can utilize an edge-sharing M1-M1 configuration-based calculation, an edge- and corner-sharing M1-M1 configuration-based calculation, or utilize both configurations.

The percolation probability is calculated using the Monte Carlo or MCMC simulation. Percolation represents a paradigmatic model of a geometric phase transition. In the classical site percolation model, the sites of a square lattice are randomly occupied with particles with probability p, or remain empty with probability 1−p. Neighboring occupied sites are considered to belong to the same cluster. In the present disclosure, the particles in the percolation are the electrons. The percolation probability is generally defined as the probability that a cluster of filled sites spans the whole lattice.

The simulations allow to determine the proportion of the redox center (M1) that is accessible and is part of the percolating network. Indeed, even when a percolation probability of 95% or more is determined for a concentration of M1, it is possible that a significant portion (e.g. 20% or more) of the M1 is inaccessible and does not form part of the percolating network. Accordingly, despite the high percolation probability calculated it is possible that the resulting electrical conductivity is not as desired. This is caused by the proportion of inaccessible M1. To improve the electrical conductivity, a concentration of M1 must be selected where the ratio of accessible to inaccessible M1 is at least 90%, preferably at least 95%. This has been demonstrated in the Example section below with Mn as M1 but the results are applicable to the other redox centers contemplated herein.

As previously explained, this improvement in electrical conductivity allows to reduce the proportion of carbon-based conductive material in the cathode to therefore improve the energy capacity of the cathode. In some cases, it is possible to tune the content of carbon-based conductive material based on the determined electrical conductivity and concentration of M1. The more conductive the disordered rocksalt-cathode active material can be made the more it is possible to reduce the content of carbon-based active material.

The cathode of the present disclosure can be defined by a weight ratio (mass ratio) of the disordered rocksalt-cathode active material:conductive material:binder as being (70+x):(20−y):z, where 0<x≤26, 0<y≤18, 2≤z≤10 and where (x−y+z)=10. It would be desirable to reduce the concentration of the conductive material (therefore increase the value of y in the weight ratio) by increasing the concentration of the disordered rocksalt-cathode active material (i.e. increase the value of x in the weight ratio). This is possible in the present methods thanks to A the improved electrical conductivity of the disordered rocksalt-cathode active material which is achieved by selecting a value of y in Formula 1 that allows to obtain a high percolation probability as well as a high ratio of accessible M1. In some embodiments, the x and y of the weight ratio can be selected such that the conductivity and the energy capacity are optimized.

In some embodiments, the disordered rocksalt-cathode active material has a structure included in a cubic Fm-3m space group having a peak of the (400) plane around 45 degrees (26) in an X-ray diffraction (XRD) pattern, or has a structure included in a cubic Fd3m space group having a peak of the (400) plane around 45 degrees (26) and a peak of the (111) plane around 20 degrees (26). In some examples, the disordered rocksalt-cathode active material may be a partial spinel DRX material corresponding to the “Fd-3m space group”.

The present disclosure provides a manufacturing method for a disordered rocksalt-cathode active material by utilizing the values determined for x, y, z, and k in Formula 1. There is also provided a method of manufacturing a cathode comprising the disordered rocksalt-cathode active material manufactured. The cathode is produced by mixing the disordered rocksalt-cathode active material, a carbon nanotube-based conductive material, and a binder, in which the carbon nanotube-based conductive material includes a multi-walled carbon nanotube (MWCNT), a single-walled carbon nanotube (SWCNT), or both, and the weight ratio of the disordered rocksalt-cathode active material:conductive material:binder is 70+x:20−y:z (wherein, 0<x≤26, 0<y≤18, 2≤z≤10, and (x−y+z)=10). Preferably, the carbon nanotube-based conductive material has a diameter of 1 nm to 20 nm and a length of 1 μm to 50 μm.

In some embodiments, the carbon nanotube-based conductive material includes a carbon nanotube-based conductive material (A) having an aspect ratio (length/diameter) of 1000 or less, a carbon nanotube-based conductive material (B) having an aspect ratio (length/diameter) of 1000 to 10,000, or both (A) and (B). When both (A) and (B) are present, the mass ratio of (A) to (B) may be from 1:1 to 1:10. Generally, the bulk volume of the conductive material of the present disclosure is preferably from 1 cm³/g to 100 cm³/g.

There are many binders suitable for producing a cathode, the binder is for example selected from the group consisting of poly(vinylidene fluoride) (PVDF), polyvinylidene fluoride-co-hexafluoropropylene, polyvinylidene fluoride-co-trichloroethylene, polyvinylidene fluoride-co-tetrafluoroethylene, polyvinylidene fluoride-co-trifluoroethylene, polyvinylidene fluoride-co-trifluorochloroethylene, polyvinylidene fluoride-co-ethylene, ethylene/tetrafluoroethylene copolymers (ETFE), fluorinated ethylene/propylene copolymers (FEP), tetrafluoroethylene/perfluoroalkoxyvinyl copolymers (PFA), tetrafluoroeth-ylene/hexafluoropropylene/vinylidene fluoride terpolymers (THV), perfluoro rubbers (PFR), glassy amorphous fluoropolymers, Polytetrafluoroethylene (PTFE), styrene-butadiene rubber (SBR), sodium salt of carboxymethyl cellulose (CMC), poly(acrylic acid) (PAA) and poly(amide imide) (PAI) and combinations thereof.

There is provided herein a method to design a disordered rocksalt structure-cathode material in order to optimize the energy density of the electrode and the conductivity. That is, the present methods provide the skill person a design direction for a cathode to fundamentally understand electrical conductivity based on the composition of the disordered rocksalt structure-cathode material. It is thus possible with the present methods to optimize a composition of a cathode by modifying the concentration of the redox center and/or of the conductive material. This is done with the first-principles calculations and simulations as described above, which can be supplemented with experimental evaluations or validations.

A deeper understanding of percolation and its effect on conductivity has been demonstrated herein by using first-principles calculations and simulations as described above to determine a composition range that secures electrical conductivity within a material even at a low conductive material ratio. In addition, the present methods can enable a high energy density electrode configuration of a disordered rocksalt cathode material system by designing a disordered rocksalt-cathode material within the corresponding composition range.

In some embodiments, there is provided a method comprising the step of experimentally determining values of x, y, and z in the weight ratio to obtain a maximum conductivity value and then basing the calculations for determining M1 and the composition of the disordered rocksalt structure-cathode material accordingly. The methods of the present disclosure can also further comprise experimentally determining the electrical conductivity for the disordered rocksalt structure-cathode material based on the selected values of x, y, z or k and the species selected for M1 and M2. The electrical conductivity can be experimentally evaluated using direct current (DC) polarization.

As demonstrated in the Example section below, energy barriers of two percolation paths (edge-sharing or corner-sharing) may be evaluated through first-principles calculations. Based on the results of the percolation evaluation of the disordered rocksalt structure cathode material, the evaluation can be performed in two model structures of a random structure based on Monte-Carlo simulation and a structure considering short-range ordering based on Markov-chain Monte-Carlo simulation. The actual conductivity of the material can be measured by the DC polarization method. When transition metals undergo a redox reaction within the material during charge/discharge (i.e., lattice oxygen may also contribute to a redox reaction at times), electrons are hopped through neighboring transition metals to contribute to the actual capacity. For lithium ions and d⁰ metals (e.g., Ti⁴⁺, Nb⁵⁺), the electron affinity is very low, making it very difficult to be used as mediators for electron hopping. Accordingly, in order to understand the electronic conductivity of the material, the role of the redox center transition metal (e.g., Mn³⁺), which is an actual percolating path, was explored. As per the Example section below, it has been demonstrated herein that it is possible to evaluate the electrochemical behavior in a high active material (low conductive material) composition according to an amount of a redox center transition metal (e.g. Mn) using disordered rocksalt cathode materials such as Li_{1.68}Mn_{1.60}O_{3.7}F_{0.3} (LMOF, 0.8 Mn per X₂ (X=anion)), Li_{1.68}Mn_{1.30}Ti_{0.30}O_{3.7}F_{0.3} (T30, 0.65 Mn per X₂ (X=anion)), and Li_{1.68}Mn_{1.15}Ti_{0.45}O_{3.7}F_{0.3} (T45, 0.575 Mn per X₂ (X=anion)), and Li_{1.2}Mn_{0.4}Ti_{0.4}O₂ (LMTO, 0.4 Mn per X₂ (X=anion)) and to determine the amount of an appropriate redox center transition metal for being used as a high-energy density electrode material.

The synthesis process of the disordered rocksalt structure cathode material (after the specific values for x, y, z and k as per Formula 1 are determined) can be a solid-state process and/or a mechanical synthesis process by combining precursors of Li, M1, M2, 0 and F in the appropriate amounts. The precursors are for example Li₂CO₃, Mn₂O₃, TiO₂ and LiF. For example, the synthesis process of the active material can include mechanochemical synthesis and solid-state synthesis. The mechanochemical synthesis can be performed by applying energy for a long period of time using a high-energy ball mill enclosed with balls for a ball mill in a ball mill vessel of an inert gas (Ar) atmosphere using a metal oxide (MₓO_{y}) or metal fluoride (MₓF_{y})-based precursor at a stoichiometric ratio. The balls for the ball mill may have a weight ratio of balls/precursor of from 15:1 to 30:1. During synthesis, energy may be controlled by rotation speed (rpm), which may also be from 400 rpm to 700 rpm. The synthesis time may also be from 20 hours to 50 hours. The solid-state synthesis is performed by mixing precursors based on metal oxides (MₓO_{y}) or metal fluorides (MₓF_{y}) dissolved in ethanol at a stoichiometric ratio using a high-energy ball mill enclosed with balls for a ball mill in a ball mill vessel by applying energy for a short period of time. During mixing, the energy may be controlled by rpm, which may also be 200 rpm to 400 rpm. The balls for the ball mill may have a weight ratio of balls/precursor of 15:1 to 30:1. The mixing time may also be 2 hours to 20 hours. After mixing, ethanol is filtered out through a filtering process and high-temperature synthesis is performed using a furnace. The high-temperature synthesis temperature may also be 700° C. to 1200° C. The synthesis time may also be 5 hours to 48 hours. The synthesized active material may be pulverized for 2 hours using SPEX ball mill equipment for nanosizing to produce a powder.

There is also provided a manufacturing method for producing a cathode by mixing the disordered rocksalt-cathode active material represented; the carbon nanotube-based conductive material; and the binder. The mixing can be performed by ball milling or other mechanical mixing means.

According to an exemplary embodiment, the disordered rocksalt-cathode active material may be selected from Li_{1.68}Mn_{1.30}Ti_{0.3}O_{3.7}F_{0.3} and Li_{1.68}Mn_{1.15}Ti_{0.45}O_{3.7}F_{0.3} (which can also be expressed as Li_{0.84}Mn_{0.65}Ti_{0.15}O_{1.85}F_{0.15} and Li_{0.84}Mn_{0.575}Ti_{0.225}O_{1.85}F_{0.15} respectively).

In some embodiments, the size of the disordered rocksalt-cathode active material may be from 50 nm to 500 nm. In some examples, for high energy implementation, the size may be a nano size of from 50 nm to 200 nm. Herein, the size may mean a length, a diameter, or a thickness based on particle shape. If the size is included within the above range, it is possible to organically secure a carbon nanotube-based conductive material and a percolating network and to improve energy density.

In some embodiments, when the carbon nanotube-based (CNT) conductive material is applied to the disordered rocksalt-cathode active material, the CNT conductive material may not only have a higher density electrode configuration within the cathode or cathode composite, but also form an organic electronic network within the electrode. For example, the carbon nanotube-based conductive material includes a multi-walled carbon nanotube (MWCNT), a single-walled carbon nanotube (SWCNT), or both.

In some embodiments, the carbon nanotube-based conductive material has a diameter of 1 nm to 20 nm and a length of 1 μm to 50 μm. when included in the mentioned range, it is possible to implement high energy density by securing disordered rocksalt structure nanoparticles and a percolating network.

In some embodiments, the carbon nanotube-based conductive material may include a carbon nanotube-based conductive material (A) having an aspect ratio (length/diameter) of 1000 or less; 500 or less; 100 or less; 50 or less; or 45 or less; 40 or less; or 30 or less; a carbon nanotube-based conductive material (B) having an aspect ratio (length/diameter) of 50 to 50,000; more than 50 to 50,000; 100 to 50,000; 300 to 50,000; 500 to 50,000; 1,000 to 50,000; 3,000 to 50,000; 5,000 to 50,000; 10,000 to 50,000; 20,000 to 50,000; or 1000 to 10,000; or both. In some examples, minimum and/or maximum values may be selected from the aforementioned values. In some examples, the mass ratio of the carbon nanotube-based conductive material (A) to the carbon nanotube-based conductive material (B) may be 1:1 to 1:10. when included in the mentioned range, it is possible to secure disordered rocksalt structure nanoparticles and a percolating network and to lower the minimum amount of conductive material required for organic electronic exchange.

In some embodiments, the bulk volume of the carbon nanotube-based conductive material may be 1 cm³/g to 100 cm³/g; 5 cm³/g to 100 cm³/g; 10 cm³/g to 100 cm³/g; 20 cm³/g to 100 cm³/g; 40 cm³/g to 100 cm³/g; 50 cm³/g to 100 cm³/g; or 60 cm³/g to 100 cm³/g. A maximum or minimum value may be selected from the aforementioned values. Since the carbon nanotube-based conductive material provides a high bulk volume compared to conventional carbon-based conductive materials, a network is formed well between the conductive material and the active material, and the content of the conductive material may be reduced, but even though applying a low content of conductive material, high energy density can be implemented from an electrode level to a cell level.

The binder may include a fluorine-based binder, aqueous binder, or both. In some embodiments, the fluorine-based binder may include at least one of a poly(vinylidene fluoride) (PVDF)-based binder, a vinylidene fluoride copolymer (VDF)-based copolymer, styrene-butadiene rubber (SBR), sodium salt of carboxymethyl cellulose (CMC), poly(acrylic acid) (PAA), and poly(amide imide) (PAI), or a combination thereof. In some embodiments, the binder may include at least one of poly(vinylidene fluoride) (PVDF), polyvinylidene fluoride-co-hexafluoropropylene, polyvinylidene fluoride-co-trichloroethylene, polyvinylidene fluoride-co-tetrafluoroethylene, polyvinylidene fluoride-co-trifluoroethylene, polyvinylidene fluoride-co-trifluorochloroethylene, polyvinylidene fluoride-co-ethylene, ethylene/tetrafluoroethylene copolymers (ETFE), fluorinated ethylene/propylene copolymers (FEP), tetrafluoroethylene/perfluoroalkoxyvinyl copolymers (PFA), tetrafluoroeth-ylene/hexafluoropropylene/vinylidene fluoride terpolymers (THV), perfluoro rubbers (PFR), glassy amorphous fluoropolymers, Polytetrafluoroethylene (PTFE), styrene-butadiene rubber (SBR), sodium salt of carboxymethyl cellulose (CMC) or any combinations thereof. In some examples, the styrene-butadiene rubber (SBR) and the sodium salt of carboxymethyl cellulose (CMC) may be included in a mass ratio of 1:99 to 99:1; 10:90 to 70:30; or 20:80 to 60:40. In some examples, the poly(vinylidene fluoride) (PVDF) based binder to the styrene-butadiene rubber (SBR) binder may be included in a mass ratio of 1:99 to 99:1; 10:90 to 70:30; or 20:80 to 60:40. In some examples, the poly(acrylic acid) (PAA) to poly(amideimide) (PAI) may be included in a mass ratio of 1:99 to 99:1; 10:90 to 70:30; or 20:80 to 60:40. When included in the mentioned range, a network between the active material and the conductive material may be formed well in the cathode, and a high energy density electrode or battery may be provided.

In some embodiments, the ratio (mass ratio) of the active material:the conductive material:the binder in the cathode may be 70+x:20−y:z, wherein 0<x≤26, 0<y≤18, 2≤z≤10, and z=10−x+y. In some examples, x may be 0<x≤26; 0<x≤23; 0<x≤22; 0<x≤20; 0<x≤18; 0<x≤15; 0<x≤12; 0<x≤10; 0<x≤8; 0<x≤5; 0<x≤3 or 0<x≤2. In some examples, y may be 0<y≤18; 0<y≤16; 0<y≤15; 0<y≤14; 0<y≤12; 0<y≤10; 0<y≤8; 0<y≤6; 0<y≤5; 0<y≤4; or 0<y≤2. In some embodiments, x is 5≤x≤26, 10≤x≤26, 15≤x≤26, 18≤x≤26, 20≤x≤26, 21≤x≤26, or 22≤x≤26. In some embodiments, y is 5≤y≤18, 10≤y≤18, 11≤y≤18, 12≤y≤18, 13≤y≤18, or 14≤y≤18. In some examples, z may be 2≤z≤10; 2≤z≤9; 2≤z≤8; 2≤z≤7; 2≤z≤6; 2≤z≤5; 2≤z≤4; or 2≤z≤3. When included in the mentioned range, it is possible to secure disordered rocksalt structure nanoparticles and a percolating network and to lower the minimum amount of conductive material required for organic electronic exchange.

In some embodiments, the cathode may further include a solvent, which can be selected from an organic solvent and water, such as at least one of acetone, tetrahydrofuran, methylenechloride, chloroform, dimethylformamide, N-methyl-2-pyrrolidone (NMP), cyclohexane, and water, or any combination thereof. The cathode may be mixed in a solvent-free state (e.g., about 0%) without including a solvent, or may be mixed by applying a solvent of more than 0%; 5% or more; 10% or more; 30% or more; 35% or less; 25% or less; 15% or less; or 3% or less. In some examples, the solvent may be removed when manufacturing the electrode.

In some embodiments, there is provided a secondary battery and a method of producing the secondary battery, wherein the secondary battery comprises a cathode which comprises the disordered rocksalt-cathode active material, an anode, and an electrolyte or separator. In preferred embodiments, the cathode energy density is improved by using a carbon nanotube-based (e.g., multi-walled carbon nanotube (MWCNT)) as the carbon-based conductive material. The energy density of the secondary battery of the secondary battery as described herein may be from 400 Wh/kg-cathode to 1000 Wh/kg-cathode; from 500 Wh/kg-cathode to 1000 Wh/kg-cathode; from 600 Wh/kg-cathode to 1000 Wh/kg-cathode; or from 700 Wh/kg-cathode to 1000 Wh/kg-cathode (mass density).

In some embodiments, the cathode may be a sheet or film coated or applied on a substrate or current collector. In such embodiments, the loading amount of the active material in the cathode may be 0.1 mAh/cm² to 10 mAh/cm².

In some embodiments, the separator can comprise a single layer of a porous film made of a synthetic resin such as polytetrafluoroethylene, polypropylene or polyethylene, or a porous film made of ceramics, or laminating a plurality of layers thereof. In addition, the separator may include a porous film of non-woven fabric or cellulose, and the like.

In some embodiments, the anode is a sheet-shaped member formed by applying and drying an anode composite paste to the surface of a metal foil current collector such as copper. The anode active material may include materials containing lithium, such as metallic lithium and lithium alloys; organic compound sintered bodies, such as natural graphite, artificial graphite, and phenol resin; and powdered carbon materials, such as coke, but is not limited thereto. In some examples, the anode may be a metal foil (e.g., lithium metal foil) or a metal thin film.

In some embodiments, the electrolyte may be a non-aqueous electrolyte solution including an electrolyte salt; and a cyclic carbonate such as ethylene carbonate, propylene carbonate, butylene carbonate, and trifluoropropylene carbonate; a linear carbonate such as diethyl carbonate, dimethyl carbonate, ethyl methyl carbonate, and dipropyl carbonate; an ether compound such as tetrahydrofuran, 2-methyltetrahydrofuran, and dimethoxyethane; a sulfur compound such as ethyl methyl sulfone and butane sultan; or a phosphorus compound such as triethyl phosphate or trioctyl phosphate.

According to one embodiment, a cathode and conductive material mixture of the cathode may be prepared by adding the prepared active material (e.g., lithium manganese based oxyhalide) and MWCNT (conductive material) in a mixing device (e.g., Premium Line 7 device from FRISTCH™) at various weight ratios (active material:conductive material:binder is 90:5:5, 92:4:4, 94:3:3, or 96:2:2), and mixing the materials at 300 rpm for 30 minutes to evenly mix the MWCNT on the surface of the lithium manganese based oxyhalide.

In some embodiments, the cathode of the battery can be manufactured by mixing the prepared cathode active material, the conductive material (MWCNT), and the binder at a weight ratio of 7:2:1 (or any other weight ratio as described herein) in N-methylpyrrolidone (NMP) to prepare a cathode composite (i.e., a cathode composition), applying the cathode composite on an aluminum current collector, and then drying and rolling the applied current collector. The anode active material used can be a 0.2 mm-thick lithium metal foil. A lithium secondary battery can be manufactured by interposing a separator between the cathode and the anode manufactured as described above to manufacture an electrode assembly, inserting the electrode assembly into a battery can, and then injecting an electrolyte. As the electrolyte, an electrolyte may be used by dissolving LiPF₆ at a concentration of 1 M in a mixed solvent of ethylene carbonate (EC):dimethyl carbonate (DMC) in a volume ratio of 1:1.

### Example

In order to substantially improve the energy density of an electrode, it is important to increase the proportion of the active material in the electrode configuration while reducing the proportion of the conductive material. The weight ratio is as previously defined: active material:conductive material:binder. The electrochemical characteristics were confirmed by increasing the ratio of the active material for Li_{1.2}Mn_{0.4}Ti_{0.4}O₂ (LMTO, 0.4 Mn per X₂ (X=anion)), which was used as the representative disordered rocksalt cathode material.

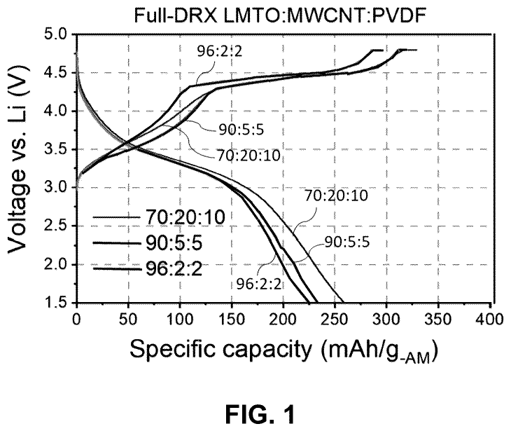

In FIG. 1, MWCNT was used as a conductive material and PVDF was used as a binder, and as illustrated in FIG. 1, the LMTO material showed a distinct capacity decrease in a first cycle when the active material content increased (when the conductive material content decreased). A first cycle discharge capacity of a 96%-active material electrode was only about 85% of that of a 70%-active material electrode.

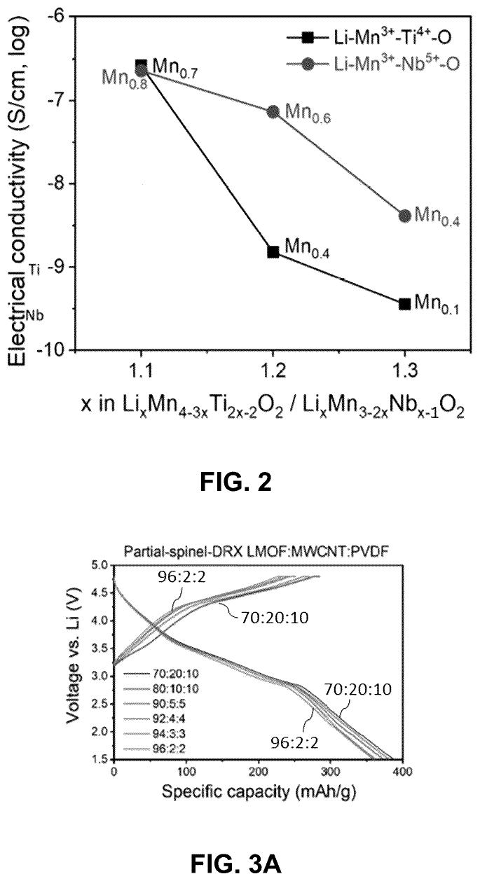

In FIG. 2, electrical conductivity was measured after synthesizing two disordered rocksalt structures, LiₓMn³⁺₄₋₃ₓTi₂ₓ₋₂O₂/LiₓMn³⁺₃₋₂ₓNbₓ₋₁O₂, by controlling the amount of redox center (Mn) (x=1.1, 1.2, and 1.3) (DC polarization analysis in FIG. 2). That is, very low electrical conductivity was shown in a Li_{1.2}Mn_{0.4}Ti_{0.4}O₂ (LMTO) composition.

As a result, it can be expected that the capacity reduction shown in the electrode composition with a high active material content (low conductive material content) in FIG. 1 is caused by the low conductivity of the material itself. However, it can be expected to enable a design of a high-conductivity material capable of maintaining a high capacity even at a high active material content (low conductive material content) through a proportional correlation between the amount of redox center (Mn) and electrical conductivity.

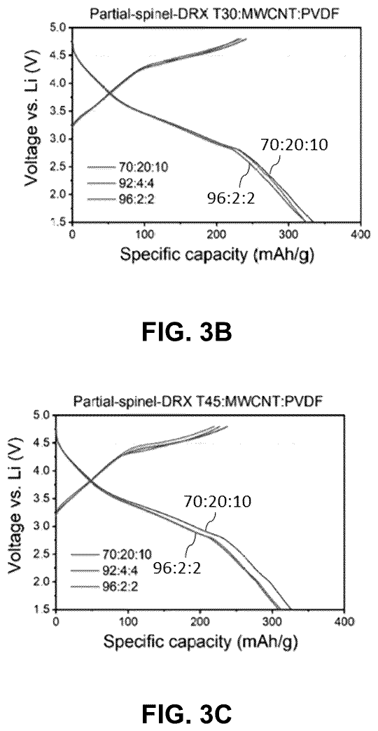

Among the representative disordered rock salt cathode materials, a partial spinel disordered rocksalt cathode material was used to be applied to a high-active material electrode composition. The results were shown in FIGS. 3A-3C. It can be seen that very high capacities are maintained even at a 96% high-active material composition in all compositions of Li_{1.68}Mn_{1.60}O_{3.7}F_{0.3} (LMOF, 0.8 Mn per X₂ (X=anion), FIG. 3A), Li_{1.68}Mn_{1.30}Ti_{0.30}O_{3.7}F_{0.3} (T30, 0.65 Mn per X₂ (X=anion), FIG. 3B), and Li_{1.68}Mn_{1.15}Ti_{0.45}O_{3.7}F_{0.3} (T45, 0.575 Mn per X₂ (X=anion), FIG. 3C). For both T30 and T45, the first cycle discharge capacity of the 96% active material electrode is approximately 95% compared to that of the 70% active material electrode (reached 85% in the case of LMTO). The above-mentioned partially spinel disordered rocksalt cathode material all contain high Mn content or 0.8 Mn per X2, and they all delivered high capacity in the high-active material electrode film. Their electrical conductivities are higher than other disordered rocksalt material.

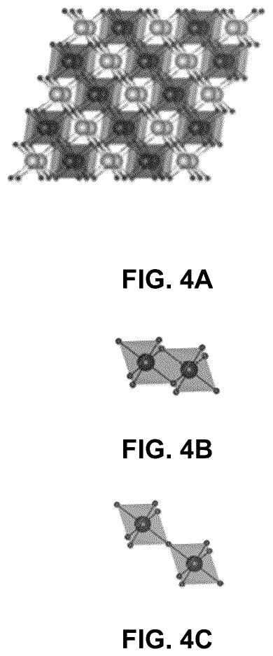

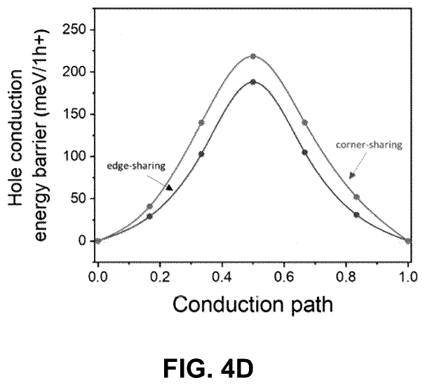

First-principles calculations and several computational simulations were performed to understand the effect of the actual amount of redox center (Mn) on the percolation within the material. First, in order to determine which path electrons were conducted within the material, the energy barriers for polaron conduction were computationally evaluated for two movable paths of in a lattice (FIG. 4A), corner-sharing Mn—Mn (FIG. 4B) and edge-sharing Mn—Mn paths (FIG. 4C). According to DFT calculation results in FIG. 4D, it can be seen that the percolating cluster (polaron conduction) is energetically slightly lower in the edge-sharing Mn—Mn path. However, because the energy difference is small (20 meV), it can be concluded that electrons are also conducted through the corner-sharing Mn—Mn path.

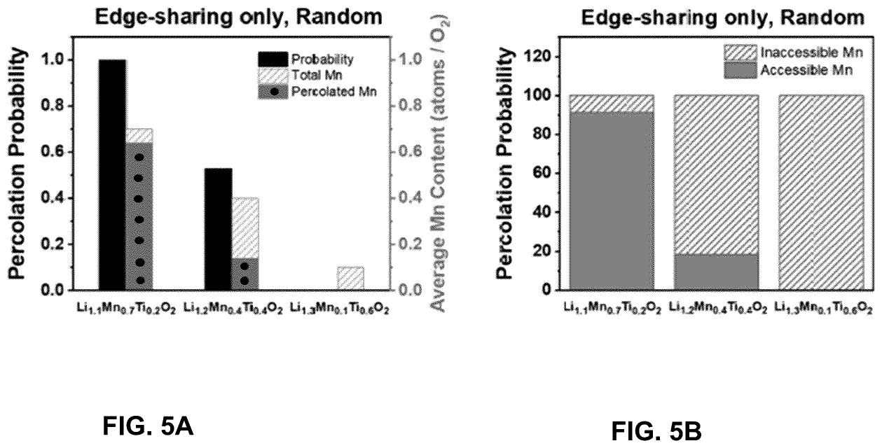

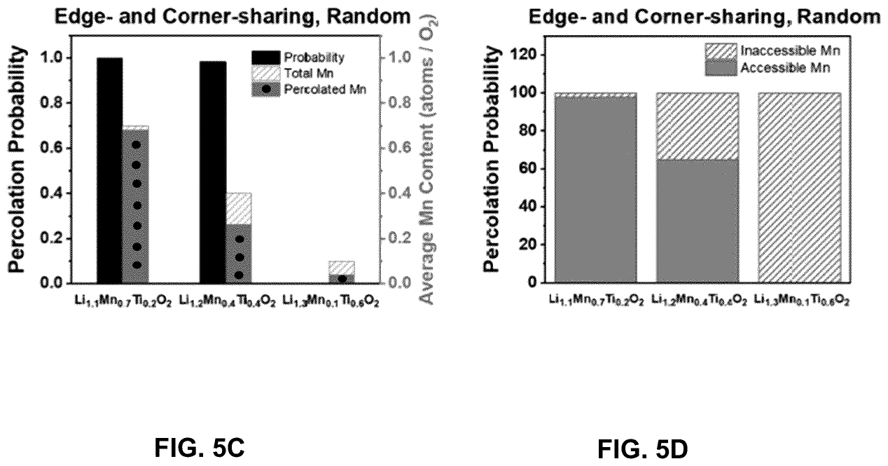

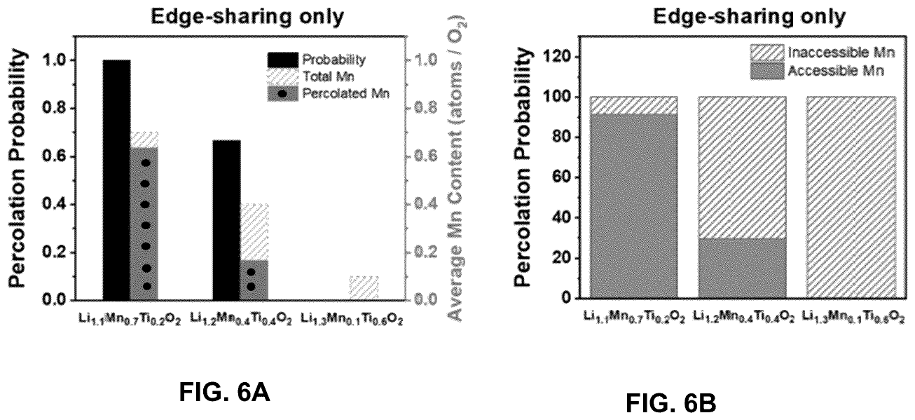

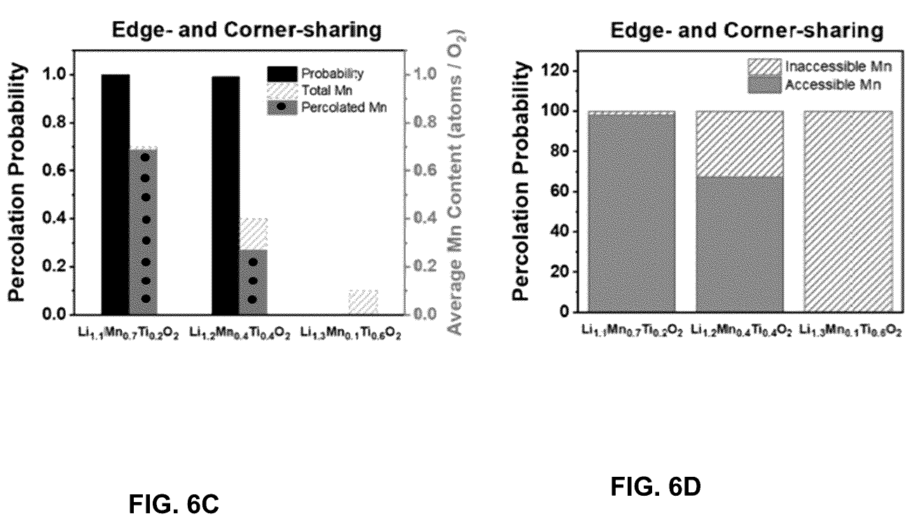

Based on the results of the calculation of the percolation path in FIG. 4D, the percolation probability according to the redox center (Mn) ratio and the ratio of redox center (Mn) participating in percolation were calculated. The percolation evaluation of the disordered rocksalt structure cathode material was performed in a random structure based on Monte-Carlo simulation (FIGS. 5A-5D) and a structure considering short-range ordering based on Markov-chain Monte-Carlo simulation (FIGS. 6A-6D). According to the random structure-based calculation results, it was confirmed that the probability of forming a percolating network is close to 100% in a 0.7 Mn per 02 composition, and the ratio of accessible Mn is also very high to have high electrical conductivity. However, it can be expected that in the 0.4 Mn per 02 composition, the probability of forming the percolating network is close to 100%, but the ratio of inaccessible Mn not included in the percolating network is significant to exhibit low conductivity characteristics, and even in the experimental results (FIG. 2), low electrical conductivity was shown. The same tendency is shown even in the calculation results based on a structure closer to the actual structure by considering short-range ordering. However, it was confirmed that the amount of accessible Mn included in the percolating cluster increased due to the reflection of the short-range ordering.

More generally FIGS. 5A-5D and 6A-6D demonstrate that when only “edge-sharing” Mn is used in the percolation simulation, then at 0.4 Mn per 02, the percolation probability is less than 100% (FIG. 6A). If only the “edge-sharing” Mn is assumed for the simulation, then 0.7 Mn leads to 100% percolation but not 0.4 Mn. Meanwhile, when the simulation assumes both “edge-sharing” and “corner-sharing” Mn in the simulation, 0.4 Mn per 02 composition can also lead to close to 100% percolation probability. So, 0.7 Mn was a more conservative value (more certain value, as corner-sharing Mn was not as conductive pathway as the edge-sharing pathway) to guarantee percolation.

In the present Example, the first-principles calculations and simulations were performed using the “The Vienna Ab initio Simulation Package”, and materials at atomic units were calculated by computer modeling based on the first-principles calculations.

What is claimed is:

1. A method of manufacturing a disordered rocksalt-cathode active material, the method comprising:
selecting values of x, z and k in Formula 1:
Li_{0.4+x}M1_{y}M2_{z}O₂₋ₖFₖ (1)
Wherein, 0<x≤1.6, 0≤z≤1, 0≤k≤0.66, and wherein M1 is a redox center selected from the group consisting of Mn, Ni, V, Co, Fe, Ir, Cr, Ru, Mo, and
combinations thereof, and M2 is a d⁰ transitional metal selected from the group consisting of Ti, Zr, V, Nb, Sn, Mo and combinations thereof;
determining a value of y in Formula 1, wherein 0<y≤1 and (x+y+z)≤1.6, for a composition of M1 and M2 by first performing step A, then second performing step B and/or step C, and then third performing step D which are as follows:
A. determining polaron energy barriers for the disordered rocksalt-cathode active material with y varying from more than 0 to up to 1,
B. determining a percolation probability by using the polaron energy barriers determined in Step A and performing a Monte Carlo simulation assuming a random crystal structure for the disordered rocksalt-cathode active material, to determine a proportion of M1 that is accessible and is part of a percolating network of the disordered rocksalt-cathode active material as opposed to M1 that is inaccessible and is not part of the percolating network,
C. determining a second percolation probability by using the polaron energy barriers determined in Step A and performing a Markov Chain Monte Carlo simulation assuming a short-range ordering of the crystal structure of the disordered rocksalt-cathode active material, to determine a proportion of M1 that is accessible and is part of a percolating network of the disordered rocksalt-cathode active material as opposed to M1 that is inaccessible and is not part of the percolating network,
D. selecting a value of y such that a ratio of M1 defined as follows is of at least 90%:
$$ratio of M 1 = \frac{accessible M 1}{total M 1}$$
wherein total M1 is the sum of the accessible M1 and not accessible M1, and wherein a proportion of accessible M1 is obtained from step B and/or C;
synthesizing the disordered rocksalt-cathode active material by mixing amounts of Li, M2, 0 and F as per the selected values of x, z, and k and further mixing an amount of M1 as per the selected value of y according to step D in order to obtain the disordered rocksalt-cathode active material.

2. The method of claim 1, wherein in step D, the ratio of M1 that is accessible and included in the percolating network is of at least 90% as determined in both steps B and C.

3. The method of claim 1, wherein the disordered rocksalt-cathode active material has a structure included in a cubic Fm-3m space group having a peak of the (400) plane around 45 degrees (2θ) in an X-ray diffraction (XRD) pattern, or has a structure included in a cubic Fd3m space group having a peak of the (400) plane around 45 degrees (2θ) and a peak of the (111) plane around 20 degrees (2θ) in the XRD pattern.

4. The method of claim 1, wherein the Monte Carlo simulation in step B applies an edge-sharing M1-M1 configuration-based calculation, an edge- and corner-sharing M1-M1 configuration-based calculation, or both.

5. The method of claim 1, wherein the Markov chain Monte Carlo simulation in step C applies an edge-sharing M1-M1 configuration-based calculation, an edge- and corner-sharing M1-M1 configuration-based calculation, or both.

6. The method of claim 1, wherein M1 is selected from the group consisting of Mn, V, Cr, Mo, Ni, Co, and combinations thereof.

7. The method of claim 1, wherein M1 is selected from the group consisting of Mn, Ni, Co, and combinations thereof.

8. The method of claim 1, wherein M1 is Mn.

9. The method of claim 1, wherein M2 is selected from the group consisting of Ti, Nb and combinations thereof.

10. A method of producing a cathode, the method comprising:
manufacturing an active material by performing the method as defined in claim 1 to obtain the disordered rocksalt-cathode active material;
combining the active material, a conductive material and a binder in a weight ratio of (the active material):(the conductive material):(the binder) being (70+x):(20−y):z respectively wherein 0<x≤26, 0<y≤18, 2≤z≤10 and (x−y+z)=10 to obtain the cathode.

11. The method of claim 10, wherein the weight ratio has a value of x that is 15<x≤26.

12. The method of claim 10, wherein the weight ratio has a value of x that is 20≤x≤26.

13. The method of claim 10, wherein the weight ratio has a value of y of from 10≤y≤18.

14. The method of claim 10, wherein the weight ratio has a value of y of from 15≤y≤18.

15. The method of claim 10, wherein the binder is selected from poly(vinylidene fluoride) (PVDF), polyvinylidene fluoride-co-hexafluoropropylene, polyvinylidene fluoride-co-trichloroethylene, polyvinylidene fluoride-co-tetrafluoroethylene, polyvinylidene fluoride-co-trifluoroethylene, polyvinylidene fluoride-co-trifluorochloroethylene, polyvinylidene fluoride-co-ethylene, ethylene/tetrafluoroethylene copolymers (ETFE), fluorinated ethylene/propylene copolymers (FEP), tetrafluoroethylene/perfluoroalkoxyvinyl copolymers (PFA), tetrafluoroeth-ylene/hexafluoropropylene/vinylidene fluoride terpolymers (THV), perfluoro rubbers (PFR), glassy amorphous fluoropolymers, Polytetrafluoroethylene (PTFE), styrene-butadiene rubber (SBR), sodium salt of carboxymethyl cellulose (CMC), poly(acrylic acid) (PAA) and poly(amide imide) (PAI) and combinations thereof.

16. The method of claim 10, wherein the conductive material is a carbon nanotube-based conductive material which comprises a multi-walled carbon nanotube (MWCNT), a single-walled carbon nanotube (SWCNT), or both.

17. The method of claim 16, wherein the carbon nanotube-based conductive material has a diameter of 1 nm to 20 nm and a length of 1 μm to 50 μm.

18. The method of claim 16, wherein the carbon nanotube-based conductive material comprises a carbon nanotube-based conductive material (A) having an aspect ratio (length/diameter) of 1000 or less, a carbon nanotube-based conductive material (B) having an aspect ratio (length/diameter) of 1000 to 10,000, or both (A) and (B).

19. The method of claim 18, wherein a mass ratio of the carbon nanotube-based conductive material (A) to the carbon nanotube-based conductive material (B) is from 1:1 to 1:10.

20. The method of claim 10, wherein a bulk volume of the conductive material is 1 cm³/g to 100 cm³/g.
